(19) United States
(12) Patent Application Publication
(10) Pub. No.: US 2017/0181406 A1
(43) Pub. Date: Jun. 29, 2017

(54) HANDGRIP FOR A LEASH, A COMBINATION OF THE HANDGRIP AND A FUNCTIONAL ELEMENT, AND THE FUNCTIONAL ELEMENT FOR USE THEREWITH

(71) Applicant: Nano Pet Products, LLC, Norwalk, CT (US)

(72) Inventor: Christopher Howse Onthank, Norwalk, CT (US)

(21) Appl. No.: 15/388,305

(22) Filed: Dec. 22, 2016

(30) Foreign Application Priority Data
Dec. 23, 2015 (NL) 2016030

(51) Int. Cl. A01K 27/00; F21V 21/40; F21L 4/00

(52) U.S. Cl. CPC A01K 27/003; F21L 4/00; F21V 21/406; A01K 27/006; A01K 27/008; A01K 27/005; F21V 23/0414

(57) ABSTRACT

A handgrip for coupling a leash, comprising a body with a connector for coupling said leash. The handgrip is characterized in that said body has an elongated shape comprising a grip part for holding said handgrip with a hand, at least one end of said body having a recess with a first coupling part for cooperation with a functional member part having a second coupling part.

### CROSS-REFERENCE TO RELATED APPLICATIONS

This application claims priority to and the benefit of the filing of Netherlands Patent Application No. 2016030, filed on Dec. 23, 2015, and the specification and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

Field of the Invention (Technical Field)

The present invention relates to a handgrip for a leash.

Description of Related Art Including Information Disclosed under 37 C.F.R. §§1.97 and 1.98

A handgrip for coupling a leash is known in the art. However, these known handgrips relate to retractable leashes. These known handgrips have a common disadvantage, namely a relatively high weight and their bulky appearance.

These problems may be solved by just holding a leash in one's hand. However, this provides a generally known disadvantage in that high forces are directly forwarded to one's hand and wrist, leading to physical problems. Also, when holding the leash itself in one's hand said hand is occupied such that any other items must be held in the other hand, leaving no room for further activities.

The invention now aims at providing a handgrip for a leash for alleviating the above mentioned problems.

### BRIEF SUMMARY OF THE INVENTION

The invention especially relates to a handgrip allowing one to combine a series of functions in said handgrip.

The invention further aims at providing a handgrip for a leash allowing a user to use his other hand for a still other function.

So as to obtain at least one of the above mentioned aims, the handgrip according to the present invention comprises the set of features as mentioned in claim 1. The handgrip according to the invention allows one to simply and quickly add a functional member part to the body of the handgrip or to remove same therefrom.

Hence, the invention relates to a handgrip for coupling a leash, comprising a body with a connector for coupling said leash, said handgrip being characterized in that said body has an elongated shape comprising a grip part for holding said handgrip with a hand, at least one end of said body having a recess with a first coupling part for cooperation with a functional member part having a second coupling part.

The handgrip according to the present invention provides the advantage that it may be provided with two connectors, each at opposite ends of the handgrip. Such provides an excellent weight distribution, which is very comfortable for the user.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic perspective view of a handgrip according to the invention;

FIG. 2 is a schematic view of a first side of the handgrip according to FIG. 1 with a top cap detached from the body;

FIG. 3 shows the handgrip according to FIG. 2 from a different angle;

FIG. 4 is a schematic view from a second side of the handgrip according to FIG. 1 with a bottom cap detached from the body; and

FIG. 5 shows the handgrip according to FIG. 4 from another angle.

FIG. 6 shows a simplified view of a handgrip according to the invention.

### DETAILED DESCRIPTION OF THE INVENTION

According to a preferred embodiment, said first and second coupling parts being mutually cooperating bayonet closures. Such provides an easy and quick addition and removal of said functional member part to said body. However, the invention is not limited to the use of a bayonet closure, providing the connectable parts with mutually cooperating thread is a possible embodiment, as well.

So as to obtain a combination of body and functional member part, it is preferred that an opening to said recess is substantially cylindrical, Such provides for a smooth closing and opening of said bayonet closure.

An especially preferred embodiment is comprised of a functional member part comprising a flashlight, said flashlight substantially directing away from said second coupling part. Such allows a user to simultaneously hold the leash and direct a flashlight, which is especially useful when walking a dog in the dark.

An especially advantageous function is obtained by providing a control button on the handgrip, allowing a user to easily switch the flashlight on or off. Accordingly, the flashlight is operable by means of a control button on the handgrip.

Since the flashlight is disconnectable from the handgrip, it provides the advantage that it can be charged in a docking station. The connection for charging the flashlight may be provided at the inner part, to wit the part of the flashlight that is positioned inside the handgrip when in use. To that end, the functional member comprising the flashlight is provided with a rechargeable battery.

So as to improve visibility to other traffic preference is given to a handgrip comprising within said recess a light guiding element leading towards a position at an outside of said handgrip, for example a light emitting display, and wherein said functional member part comprises a light source directing towards said light guiding element at the inside of said handgrip, such that said light is visible at said outside of said handgrip. The light source provided at the functional member part ensures visibility to following traffic. This combination of handgrip with a functional member providing a safety light on the handgrip is a novel feature improving safety of the user.

It may be preferred to hold more than one handgrip, for example when walking more than a single dog. In such case, preference is given to a handgrip wherein said functional member part is comprised of a connector comprising at a first position said second coupling part for coupling said connector with said handgrip and at a second position another second coupling part for coupling said connector with another handgrip, thereby coupling two handgrips through said connector.

The connection between the body and the functional member part is preferably obtained by a bayonet closure wherein the body of said handgrip has a substantially circumferential edge defining said recess, said recess being enclosed by an inner wall extending inwardly from said edge, and wherein said functional member part has a shoulder abutting said edge when in mutually coupled position and a side wall at least partly aligned with said inner wall, each of said inner wall and side wall comprising a mutually cooperating protrusion such that when in a coupled position the protrusion on the inner wall of the body is positioned between the protrusion on the side wall of said functional member part and the body's edge. This ensures an easy and quick coupling of body and functional member part. As a matter of fact, said parts may be embodied such that the inner wall is provided on the functional member part.

So as to be able to easily add another functionality, a washer may be positioned between said body and said functional member part. Said washer may be provided with another function, for example a clip for holding a bag, like a poop bag. In combination with a functional member part providing a flash light function, such washer adds additional functionality without substantially adding weight or volume to the handgrip according to the invention.

As a matter of fact, said functional member part as such may also comprise a connector that is embodied for coupling a bag, preferably a poop bag.

An especially preferred embodiment is comprised of a handgrip with a body having a elongate bent shape, providing a relatively long outer part and a relatively short inner part. In such embodiment, a control button for controlling a functional member part being is preferably provided at said relatively long outer part of said body.

Allowing a user to connect a forceful functional member to the handgrip is obtainable through a double lock. A first connection may be provided near an outer rim of the body, whereas a second connection may be provided at a position inside the handgrip. For example, this allows a ball thrower to be connected to the handgrip according to the present invention. Also an umbrella can be connected properly to the handgrip according to the present invention, most preferably by means of such double lock.

The advantage of a connector provided at the handgrip allows a user to connect the handgrip itself to another item, for example to a bike when “biking” a dog instead of walking a dog. Also, the handgrip may be connected to a stroller or a shopping cart if provided with a mutually operable connection. This allows one to have at least one and in many cases even two hands free for other activities.

A still highly preferred embodiment is obtainable by connecting a plurality of functional members to a single handgrip. Each first functional member may be provided with its own second connector, allowing another functional member to be stacked upon said first functional member. Such stacks may be repeated as many times as manageable by the user.

In the figures, the same and similar parts are identified and denoted by the same reference numerals. However, for ease of understanding the invention, not all parts that are necessary for a practical embodiment are shown in the drawing. The drawings only show schematic embodiments.

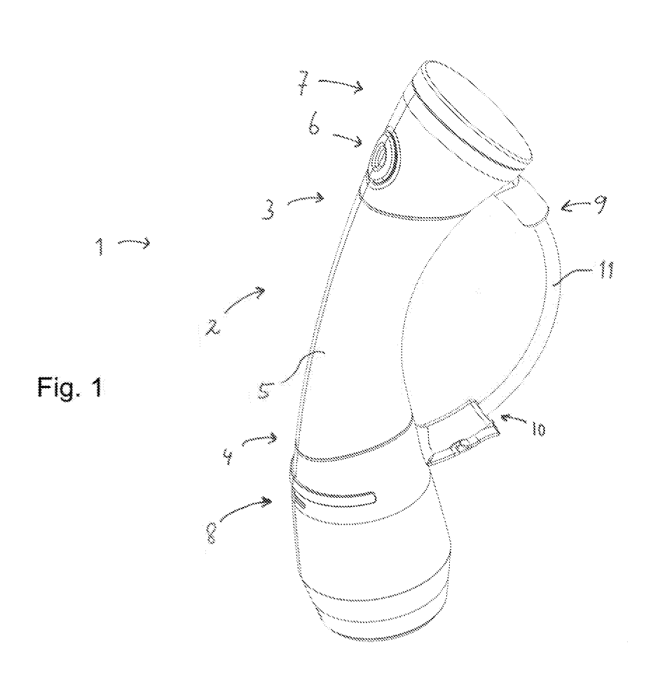

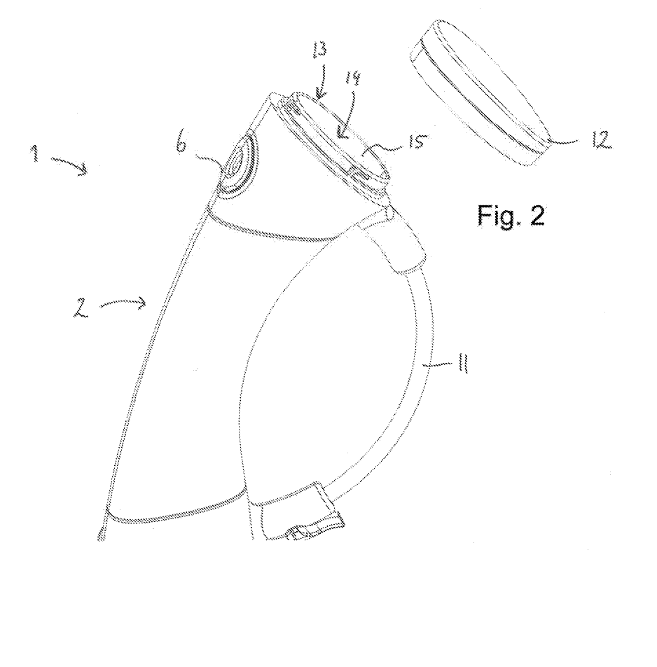

FIG. 1 and FIG. 2 show a perspective view of a handgrip 1 according to the present invention. The handgrip 1 comprises a body 2 with a grip part 5 to be held by the hand of a user. For example, the thumb part of a hand may be positioned near a first end 3 of said grip part 5, whereas the pink of the hand of said user may be positioned near a second end 4 of said grip part 5. The fingers or knuckles of the hand may be positioned between the grip part 5 and a guiding rail 11. This allows one to easily control a button 6, for example for controlling a flash light or a clicker, provided at an end part 7 of said handgrip 1. Such multi-function control button is a novel feature providing huge advantage to the handgrip since many different functional members may be controlled by a single handgrip. In the embodiment shown, the other end 8 of said handgrip 1 comprises a container for bags.

The guiding rail 11 may be provided with a connector (not shown) that is slidingly coupled to said guiding rail 11. The connector may travel between two end positions 9, 10 of said guiding rail 11. Hence, a leash that is coupled to said connector may travel between said end positions 9, 10 as well.

FIG. 2 shows the handgrip 1 with a top cap 12 detached from the body 2. The cap 12 may be comprised of said flash light or a clicker. The button 6 is operably connected to a switch (not shown) of said flashlight for turning said light on or off. Analogously, the button may be operably connected to said clicker for operating same.

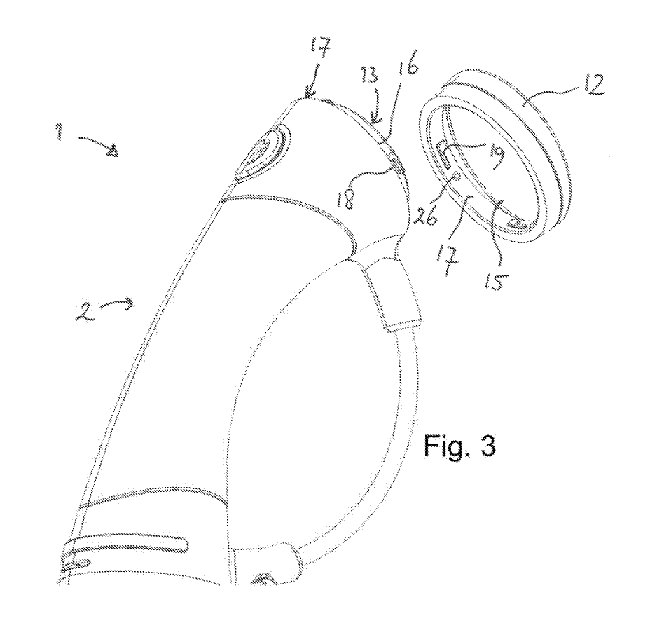

As shown in FIG. 2, the body 2 of said handgrip 1 has a substantially circumferential edge 13 defining a recess 14, said recess 14 being enclosed by an inner wall 15 extending inwardly from said edge 14 as well as an outer wall 16 extending at the outside from said edge 14. The body 2 has a shoulder 17 at some distance from the edge 13. The cap 12, being a functional member part like a flashlight or a clicker or any other functional member part, contacts with its inner end wall 15 as shown in FIG. 3, said edge 13 when in mutually coupled position. The inner side wall 17 of cap 12 is at least partly aligned with said outer wall 16. Each of said inner wall 17 and outer wall 16 comprising a mutually cooperating protrusion 18, 19 such that when in a coupled position the protrusion 18 on the wall 16 of body 2 is positioned between the protrusion 19 on wall 17 of said functional member part 12 and the body's edge 13. This ensures a locking of part 12 on said body 2.

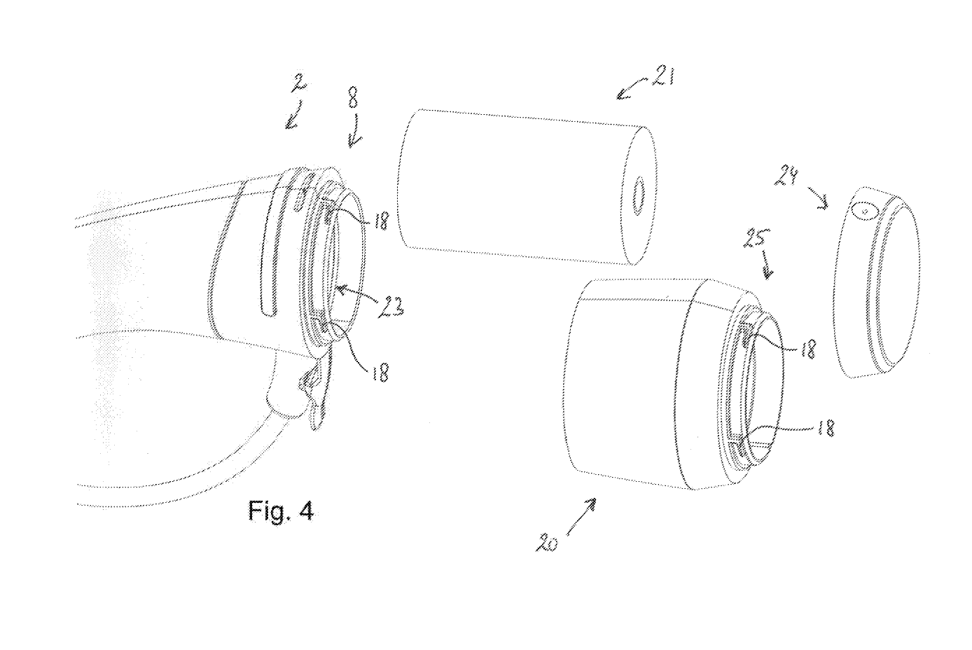

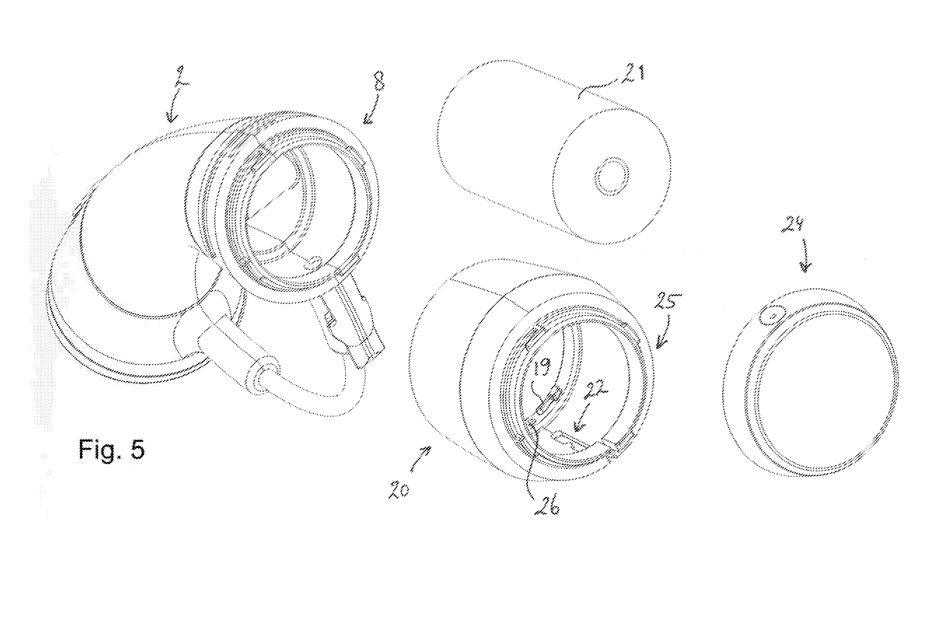

FIG. 4 shows a schematic perspective view of the handgrip 1 from the bottom side, i.e. the end of the handgrip 1 opposite the end as shown in FIGS. 2 and 3. A relatively large functional bottom member 20 is shown in a detached situation with respect to the body 2. Bottom member 20 is substantially provided for locking a container 21 inside body 2 of handgrip 1. Said container 21 may comprise bags, for example for collecting dog's feces. Said container 21 may be provided with an opening (not shown) at its side, for removing bags through a slot 22 (see FIG. 5) provided in said bottom member 20. Hence, as a first step said container 21 is inserted inside a recess 23 at the body's bottom end 8, after which bottom member 20 is positioned on top of said bottom end 8, covering part of said container 21 protruding from said body 2. Then, end cap 24 is placed for covering the end 25 of said bottom member 20.

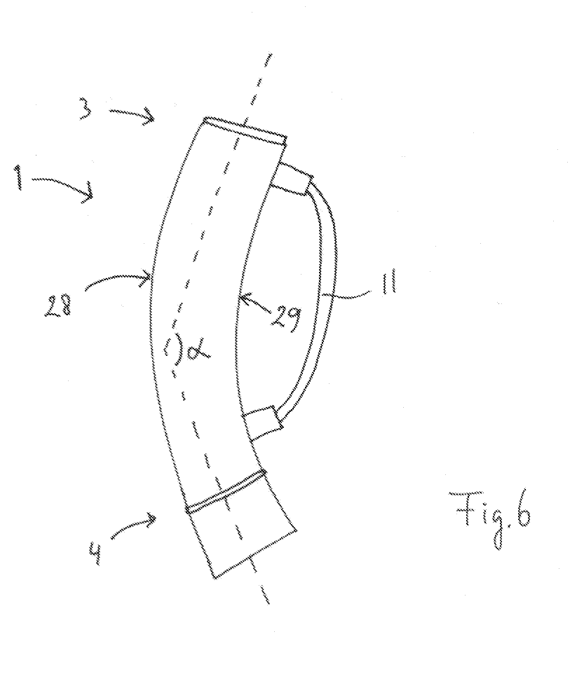

FIG. 6 shows a simplified view of a handgrip 1 according to the invention. It is clear that both longitudinal ends 3, 4 of the handgrip 1 are positioned at an angle “α” with respect to each other. Note that at end 4 a connector has been coupled. This angle α is about 140°. Due to the bent shape of the handgrip 1, the handgrip has a relatively long outer part 28 and a relatively shorter inner side 29. When holding the handgrip 1, the fingers will be positioned mostly at the shorter part 29, whereas the palm of the hand will be positioned substantially at longer part 28.

From the figures it is clear that a versatile handgrip 1 is obtained. An advantage of the present handgrip is that many functions may be combined in a single handgrip 1, as mentioned above. More in particular, it is preferred if all connecting members 18, 19 are substantially identical such that an end cap 24 may be used for covering both the bottom member 20 and top end 7 of body 2.

A click-on coupling is obtained with the combination of mutually cooperating protrusion 18, 19 by providing a further protrusion 26, as shown in FIG. 3 and FIG. 5. Part 27 of protrusion 18 is locked behind said protrusion 26, ensuring a safe coupling.

Note that in the specification and claims, “about” or “approximately” means within twenty percent (20%) of the numerical amount cited.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A handgrip for coupling a leash, comprising a body with a connector for coupling said leash, wherein said body has an elongated shape comprising a grip part for holding said handgrip with a hand, both longitudinal ends of said body having a recess with a first coupling part for cooperation with a functional member part having a second coupling part.

2. The handgrip according to claim 1, said first and second coupling parts being mutually cooperating bayonet closures.

3. The handgrip according to claim 1, wherein an opening to said recess is substantially cylindrical.

4. The handgrip according to claim 1, said functional member part comprising a flashlight, said flashlight substantially directing away from said second coupling part.

5. The handgrip according to claim 4, said handgrip comprising within said recess a light guiding element leading towards a position at an outside of said handgrip and wherein said functional member part comprises a light source directing towards said light guiding element at the inside of said handgrip, such that said light is visible at said outside of said handgrip.

6. The handgrip according to claim 1, wherein said functional member part is comprised of a connector comprising at a first position said second coupling part for coupling said connector with said handgrip and at a second position another second coupling part for coupling said connector with another handgrip, thereby coupling two handgrips through said connector.

7. The handgrip according to claim 1, the body of said handgrip having a substantially circumferential edge defining said recess, said recess being enclosed by an inner wall extending inwardly from said edge, and said functional member part having a shoulder abutting said edge when in mutually coupled position and having a side wall at least partly aligned with said inner wall, each of said inner wall and side wall comprising a mutually cooperating protrusion such that when in a coupled position the protrusion on the inner wall of the body is positioned between the protrusion on the side wall of said functional member part and the body's edge.

8. The handgrip according to claim 1, further comprising a washer positioned between said body and said functional member part.

9. The handgrip according to claim 1, said functional member part comprising a connector that is embodied for coupling a bag.

10. The handgrip according to claim 9, said functional member part comprising a connector that is embodied for coupling a poop bag.

11. The handgrip according to claim 1, said body having a elongate bent shape, such that said recesses at longitudinal ends of said body are positioned at an angle with respect to each other, wherein an angle between longitudinal axes through a first and a second of said handgrip's recesses is between 100° and 170°

12. The handgrip according to claim 11, wherein an angle between longitudinal axes through a first and a second of said handgrip's recesses is between 110° and 160°.

13. The handgrip according to claim 12, wherein an angle between longitudinal axes through a first and a second of said handgrip's recesses is between 120° and 160°.

14. The handgrip according to claim 1, said body having a elongate bent shape, providing a relatively long outer part and a relatively short inner part, said body having a control button for controlling a functional member part being provided at said relatively long outer part of said body.

15. The handgrip according to claim 1, wherein a first connection is provided near an outer rim of the body, and a second connection is provided at a position inside the handgrip.

16. A combination of a handgrip according to claim 1 and a functional element, said functional element having at a first end a second coupling part for cooperative coupling with said handgrip and at an opposite end a recess with a coupling part substantially similar to said handgrip's first coupling part for coupling another functional element.

17. A functional element for use in a combination according to claim 16, said functional element having at a first side a second coupling part for cooperative coupling with said handgrip and at an opposite side a recess with a coupling part substantially similar to said handgrip's first coupling part for coupling another functional element.
